(19) United States
(12) Patent Application Publication
(10) Pub. No.: US 2011/0057571 A1
(43) Pub. Date: Mar. 10, 2011

(54) DEVICE AND METHOD FOR CONTROLLING THE COLOR POINT OF AN LED LIGHT SOURCE

(75) Inventors: Bernd Ackermann, Aachen (DE); Dirk Hente, Wuerselen (DE); Christoph Martiny, Aachen (DE); Erik Nieuwlands, Eindhoven (NL); Georg Sauerlaender, Aachen (DE); Matthias Wendt, Wuerselen (DE)

(73) Assignee: KONINKLIJKE PHILIPS ELECTRONICS N.V., EINDHOVEN (NL)

(21) Appl. No.: 12/990,800

(22) PCT Filed: May 4, 2009
(86) PCT No.: PCT/IB09/51809

§ 371 Date: Nov. 3, 2010

(30) Foreign Application Priority Data
May 9, 2008 (EP) 08103878.8

(51) Int. Cl. H05B 37/02

(52) U.S. Cl. 315/158

(57) ABSTRACT

The present invention relates to a device and method for controlling the color point of an LED light source (50). Color point control is a most interesting product feature both for white and colored LED light sources. In known methods for the color control of RGB LED light sources use is made of flux and color sensors. However, there are difficulties with respect to sensing quickly changing ambient light, deeply dimmed colors, coordinating the measurements with the switching of the LEDs, and controlling the color in LED light units comprising a number of independent LED lamps, e.g. segmented wall washers and LCD backlights. It is proposed according to the present invention to control the color of the LED light source (50), using a model-based feed forward approach. Factors relating the parameters controlling the LED currents to the brightness for the different colors (and segments) are stored and used for open loop control. A slow-running procedure continuously measures and updates these factors. Whilst the measurements are e.g. synchronized with the PWM, the procedure itself can run considerably slower and updates the factors asynchronously.

### FIELD OF THE INVENTION

The present invention relates to a device and a corresponding method for controlling the color point of an LED light source.

### BACKGROUND OF THE INVENTION

Light emitting diode (LED) white light sources are expected to have a major impact on the general illumination market. White LED lamps based on additive color mixing have distinct advantages compared with white LED lamps based on phosphor-conversion: potentially higher efficiencies, adjustable color temperature, and the possibility to produce colored light. Color point control is a most interesting product feature both for white and colored light. Electronic compensation of manufacturing spread/aging/temperature/current-dependent color variation has the potential to realize substantial cost advantages and may even be the only commercially viable solution. Color stability and reproducibility will be very important factors for a mass market: It must be possible to operate lamps with nominally identical color points next to each other without noticeable color differences. Furthermore, it must be possible to replace one of these lamps, even after some years, also without noticeable color differences. Color control is required to achieve these goals.

The most important methods known for color control of RGB LED lamps are based on using a flux sensor, possibly together with a temperature sensor, or using a color sensor. As to using a flux sensor, four flux sensor readings for different combinations of LEDs being switched on are required to determine the brightness of the three colors Red, Green, and Blue. One of the flux readings is required to take the impact of ambient light into account. Obviously, the brightness values of a combination of a larger number of LED colors can be determined in a similar way by a larger number of flux readings.

For amplitude-modulated LEDs it is known from U.S. Pat. No. 6,127,783 to take the set of required flux readings in a measure sequence. Within each measure sequence sampling pulses triggering the flux measurements must be synchronized with the LED current pulses. Equally spaced sampling pulses are used frequently. The measured flux values resulting from the measure sequences are incorporated into a cycle-by-cycle color control of the LED lamp.

It is furthermore known from U.S. Pat. No. 6,596,977 to apply a similar procedure to pulse width modulated LEDs, also within a cycle-by-cycle control scheme. However, the time length of the measure sequence can no longer be chosen freely but is equal to the PWM period. Furthermore, the current pulses must be timed such that each color is switched on for the required duty cycle. This imposes severe limitations on the proper location of the sampling pulses that need to be synchronized with and properly placed within the pattern of current pulses.

As to using a color sensor for color control as described in U.S. Pat. No. 6,507,159, usually a color sensor comprises three flux sensors, each covered with a suitable optical filter such that it is sensitive primarily in the red, green, and blue part of the optical spectrum, respectively. Using such a color sensor, color and brightness of the light emitted by a lamp can be measured simultaneously. The impact of ambient light can be taken into account by measuring it in sequences of intervals where the lamp is switched off for a short time similar to the measure sequences described above for amplitude modulated LEDs. This color control method can also be extended to applications using more than three primary colors.

The brightness of the different LED colors can be measured more easily than the intensity of the ambient light. Whilst it is exactly known for the different LED colors whether they are switched on or off at a specific sampling pulse, the ambient light can change rapidly from one sampling pulse to the next due to artificial light sources being switched on or off. This can falsify the flux or color measurements, and as a consequence disturb severely the cycle-by-cycle control of the LED lamp. Ultimately, this can result in flickering of the LED lamp.

If the flux sensor receives significantly less light of one color than of the other colors, then it might be desirable to increase the fraction of measurements involving this color. This is not feasible in the known rigid measurement procedures.

In the case of pulse width modulation, timing of current pulses and sampling pulses within a PWM period can get very complicated and require excessive computational effort.

These problems will be even more severe for LED lamps comprising several LED light sources that may be arranged e.g. in a string (e.g. a wall washer) or in a matrix, e.g. a LCD backlight. Furthermore, for this kind of LED lamps it is desirable that either all or at least some of the LED light sources share part of the hardware, e.g. sensors or controllers. Then, the number of LED strings (an LED string usually comprises a number of LEDs having the same color and being provided with the same LED current) to be controlled by one sensor and controller would be considerably larger than for a lamp with 3 or more primary colors. Furthermore, it may be impractical to isolate the segments optically from each other, which would result in significant crosstalk between the segments, i.e. each LED string influencing virtually all optical sensors.

### SUMMARY OF THE INVENTION

It is an object of the present invention to provide a device and a corresponding method for controlling the color point of an LED light source more efficiently and for overcoming the above-explained problems.

In a first aspect of the present invention, a device for controlling the color point of an LED light source is presented comprising:

a parameter input for receiving color point information and brightness information indicating a desired color point and brightness of said LED light source,

a measurement input for receiving temperature information and optical output information, indicating i) a temperature, ii) a color and/or iii) brightness of said LED light source and/or fluxes of the primary colors of said LED light source,

a feed forward calculation unit for determining control parameters for controlling the color point of said LED light source by use of a feed forward algorithm based on said color point information, said brightness information, said temperature information and feed forward parameters,

a parameter output for outputting said control parameters to said LED light source,

a feed forward parameter storage unit for storing said feed forward parameters, and

a feed forward parameter correction unit for determining actual feed forward parameters, based on the information received by said parameter input and said measurement input and for updating the feed forward parameters stored in said feed forward parameter storage unit by said actual feed forward parameters.

In a further aspect of the present invention, a corresponding method is presented.

Preferred embodiments of the invention are defined in the dependent claims. It will be understood that the claims directed to the method and the computer program have similar and/or identical preferred embodiments as the dependent claims directed to the device.

The invention is based on the idea that the influencing factors causing color variations (in particular “temperature” and “aging”) change slowly compared to the time length of a PWM period or measure sequence. Therefore it is proposed by the present invention to control the color of the LED lamp (including at least one LED light source and the control electronics), using a model-based feed forward approach. Factors relating the current amplitude and/or the duty cycles of the current pulses to the brightness for the different colors (e.g. of the different segments in the case of a LED lamp comprising several LED lamps) are stored and used for open loop control. This corresponds to using the proposed control method in conjunction with amplitude and/or PWM modulation of the LED currents.

All known methods for color control are based on the assumption that optical measurements can be carried out ad hoc and can be used promptly in the color control. With arbitrarily set values and in difficult areas (neighboring lamps, which quickly change their brightness), these assumptions are not always fulfilled, leading to flickering of the lamp.

Preferably, the feed forward calculation unit does not only determine control parameters for controlling the color point of said LED light source, but also for controlling the brightness of said LED light source.

According to the present invention this flickering is suppressed even if these assumptions are not fulfilled. It uses information known from previous uses of the lamp to set color and brightness as accurately as possible, even if no more signals are provided from any sensor. With the invention it is much less critical if the measurement of temperature fails or is missing. In this case a suitably defined typical operating temperature can be used, possibly taking into account the current power consumption.

It is important to note that the proposed control method is independent of the modulation scheme used for the LED currents. Preferably, a slowly running procedure continuously measures and updates the factors determining the feed forward control of the LED currents. Updates are made only if there are no doubts about errors in the underlying measurements due to e.g. fast changes of the ambient light.

According to an embodiment, the procedure can decide which measurement conditions, e.g. number and type of LED colors switched on, are to be applied next. If useful, some kinds of measurements can be taken more frequently than others, e.g. those involving a LED color with a (currently) small brightness. In the case of PWM, as proposed according to an embodiment, it may be sufficient to take only one measurement (or a small number of measurements) within each PWM period. The corresponding sampling pulse(s) is (are) placed within the PWM period such that the current pulses can be timed conveniently.

Preferably, a moving average filter can be provided, e.g. as part of the feed forward parameter correction unit, for averaging actual feed forward parameters. This filter, whose function and structure is generally known in the art, averages the measured parameter values from recent (e.g. from the 20 recent) measurements and discards “out of range” measurements.

Preferably, said forward parameter correction unit is continuously active to continuously update the feed forward parameters stored in said feed forward parameter storage unit, so that there is no need to wait for a certain (external) signal before the necessity for an update is checked and/or an update is carried out.

Still further, the forward parameter correction unit is preferably adapted for asynchronously updating the feed forward parameters stored in said feed forward parameter storage unit. This embodiment avoids time critical events and simplifies the implementation.

According to a further embodiment, said feed forward parameter correction unit is adapted to update the feed forward parameters stored in said feed forward parameter storage unit by said actual feed forward parameters, if the deviation between said actual feed forward parameters and said feed forward parameters stored in said feed forward parameter storage unit exceeds a predetermined limit. This avoids malfunction of the device, however, these measures are obsolete if the moving average filter works correctly. The predetermined limit can, for instance, be obtained by estimating the resulting color error; if this color error exceeds, for instance, 0.5 or 1% an update will be made.

Generally, any modulation scheme can be applied according to the present invention for controlling the LED light source. The feed forward calculation unit is preferably, however, adapted for determining pulse width modulation parameters or amplitude modulation parameters as said control parameters.

According to another aspect, the present invention relates to an LED light unit comprising:

a LED light source,

a sensor unit for sensing i) temperature and ii) color and/or flux and for generating temperature information and optical output information indicating) a temperature, ii) a color and/or iii) brightness of said LED light source and/or fluxes of the primary colors of said LED light source,

a device as claimed in claim 1 for controlling the color point of said LED light source.

Here, an LED light unit can be understood to be an LED lamp (having only a single LED light source or more than one LED light source and the required control electronics), but also an LED lamp array comprising more than one LED lamp.

Preferably, the sensor unit comprises a color sensor for measuring the color of said LED light source. However, in a simpler embodiment, the sensor unit comprises only a (single) photodiode for measuring the brightness of said LED light source instead of such a color sensor. In this simpler embodiment only the brightness of each single LED string is measured by suitably coordinating the measurement with the control signal (providing the control parameters to the LED light source). Preferably, the sensor unit is adapted for asynchronously measuring i) a temperature and ii) a color of said LED light source and/or fluxes of the primary colors of said LED light source.

According to a further embodiment, the LED light source comprises two LED strings instead of generally three LED strings (for the three colors red, green and blue). With this embodiment the setting of colors can only be approximated. However, it is possible with this embodiment to vary the color temperature of white light. Thus, this embodiment is less accurate, but cheaper.

According to a still further embodiment, the LED light source comprises four or more LED strings. The control can be implemented similar to that used for three LED strings. The additional degrees of freedom are used to optimize further parameters, e.g. energy efficiency and color reproduction.

In the case where two or more LED light sources are provided in the LED light unit, it is possible that they share a common parameter input, feed forward parameter correction unit and/or optical sensor unit for sensing color and/or flux of said LED light sources, thus reducing the number of elements and costs. This is particularly useful in applications like segmented wall washers or backlights.

According to another aspect, the present invention also relates to a computer program comprising program code means for causing a computer to carry out the steps of the claimed method when said computer program is carried out on a computer.

### BRIEF DESCRIPTION OF THE DRAWINGS

These and other aspects of the invention will be apparent from and elucidated with reference to the embodiment(s) described hereinafter. In the following drawings:

FIG. 1 shows a diagram illustrating flux measurement for amplitude modulated LEDs according to U.S. Pat. No. 6,127,783,

FIG. 2 shows a diagram illustrating flux measurement for pulse width modulated LEDs according to U.S. Pat. No. 6,507,159,

FIG. 3 shows a segmented LED-based LCD backlight,

FIG. 4 shows an embodiment of sensors and controllers for two LED lamps,

FIG. 5 shows flux measurement for pulse width modulated LEDs according to the present invention,

FIG. 6 shows a block diagram of a first embodiment of a device according to the present invention,

FIG. 7 shows a block diagram of a second embodiment of a device according to the present invention,

FIG. 8 shows a block diagram of a third embodiment of a device according to the present invention.

### DETAILED DESCRIPTION OF THE INVENTION

Before details of the present invention are explained and illustrated, a theory of additive color mixing will be discussed.

If the light of n light sources is mixed (additive color mixing), then the luminous flux and chromaticity coordinates, i.e. brightness and color, of the mixed light can be calculated from the luminous flux and chromaticity coordinates of the n light sources.

Additive mixing of the light of n light sources with power spectral densities Pᵢ(λ), i=1, . . . , n, results in mixed light with the power spectral density

$$P ( λ ) = {\sum }_{i = 1}^{n} {P}_{i} ( λ ) \qquad ( 1 )$$

The tristimulus values of the mixed light are

$$\begin{matrix}X = {\int }_{λ} \overline{x} ( λ ) P ( λ ) d λ & ( 2 ) \\ Y = {\int }_{λ} \overline{y} ( λ ) P ( λ ) d λ & ( 3 ) \\ Z = {\int }_{λ} \overline{z} ( λ ) P ( λ ) d λ & ( 4 )\end{matrix}$$

where x̅(λ), y̅(λ), and z̅(λ) are the color matching functions corresponding to red, green, and blue, respectively. The tristimulus values X, Y, and Z of the mixed light are the sum of the tristimulus values Xᵢ, Yᵢ, and Zᵢ of the n light sources:

$$X = {\sum }_{i = 1}^{n} {X}_{i} ; Y = {\sum }_{i = 1}^{n} {Y}_{i} ; Z = {\sum }_{i = 1}^{n} {Z}_{i} \qquad ( 5 )$$

The green color matching function y̅(λ) has been chosen such that it is identical to the eye sensitivity function V(λ), i.e.

y̅(λ)≡V(λ) (6)

Therefore, the luminous flux Φₗᵤₘ of the mixed light is proportional to its Y tristimulus value

$${Φ}_{lum} = 683 \frac{lm}{W} {\int }_{λ} V ( λ ) P ( λ ) d λ \qquad ( 7 )$$

The constant factor 6831 m/W has been introduced for historical reasons.

The chromaticity coordinates x and y of the mixed light are

$$\begin{matrix}x = \frac{X}{X + Y + Z} & ( 8 ) \\ y = \frac{Y}{X + Y + Z} & ( 9 )\end{matrix}$$

They are obtained from the chromaticity coordinates xᵢ and yᵢ and the luminous fluxes Φ_{lum,i} (or tristimulus values Yᵢ,

$${Φ}_{lum , i} = 683 \frac{lm}{W} {Y}_{i} )$$

of the n light sources

$$\begin{matrix}x = \frac{{\sum }_{i = 1}^{n} {x}_{i} \frac{{Y}_{i}}{{y}_{i}}}{{\sum }_{i = 1}^{n} \frac{{Y}_{i}}{{y}_{i}}} & ( 10 ) \\ y = \frac{{\sum }_{i = 1}^{n} {Y}_{i}}{{\sum }_{i = 1}^{n} \frac{{Y}_{i}}{{y}_{i}}} & ( 11 )\end{matrix}$$

The luminous flux of the mixed light is

$${Φ}_{lum} = {\sum }_{i = 1}^{n} {Φ}_{lum , i} \qquad ( 12 )$$

The variation of LEDs' luminous fluxes and chromaticity coordinates corresponds to the variation of their brightness and color. The light output characteristics (brightness and color/luminous flux and chromaticity coordinates) of LEDs depend on

manufacturing spread,

aging,

junction temperature, and

forward current.

Manufacturing spread can be dealt with by calibration.

Aging is a slow process. Therefore, for a certain period of time after calibration, light output of LEDs is/can be known if their junction temperature and forward current are known. Junction temperature can be measured indirectly: (i) from the temperature dependence of its current versus voltage characteristics (for which purpose the forward voltage has to be measured, usually for two forward current values), (ii) from the temperature of a temperature sensor nearby. Forward current is a set-point of the color control and is regulated to this set-point in an internal control loop within the LED driver.

U.S. Pat. No. 6,411,046 describes how chromaticity coordinates and luminous flux (of red, green, and blue LEDs, respectively) can be represented as second order polynomial functions of the heat sink temperature for a RGB LED lamp. “Heat sink temperature” means here actually the temperature measured using a temperature sensor that is in good thermal contact with the heat sink. Also, the heat sink is in good thermal contact with the LEDs.

The forward current is often kept constant and the luminous flux of LEDs is regulated via the duty cycle of a PWM. Thus, the forward current is either zero or equal to a nominal value, but it varies as a function of time. However, it would also be possible to model chromaticity coordinates and luminous flux as a function of the LED forward current amplitude in a way similar to that described for the junction temperature dependence in U.S. Pat. No. 6,411,046.

Using second order polynomials, crosstalk between junction temperature and forward current amplitude dependence could be accounted for, which is however usually negligible.

It is essential for this state of the art that the relation between luminous flux and forward current changes with time (aging), whilst the relations between chromaticity coordinates and junction temperature/forward current do not. A temperature feed forward block gets the LED junction temperatures. From these it determines the chromaticity coordinates of the LEDs (e.g. as outlined in U.S. Pat. No. 6,411,046).

Then, from the above equations (10), (11) and (12) it determines what the Y, tristimulus values/luminous flux values of the LEDs should be. This is unique if there are 3 LED colors. If more than 3 colors are mixed then there is/are additional degree(s) of freedom that can be used to optimize e.g. lamp efficiency and/or color rendering.

The LED peak wavelengths are determined, since the sensitivity of the sensors used to measure luminous fluxes depends on the wavelength. It is not essential where this happens, but the values must be available in the luminous flux controller.

In this way, everything independent of LED aging is dealt with in the temperature feed forward control. The impact of the luminous flux versus forward current characteristics is eliminated by feed forward controlling the luminous flux in a way analogous to the temperature feed forward control described in U.S. Pat. No. 6,411,046 and outlined above, as proposed by the present invention. This is explained below in detail.

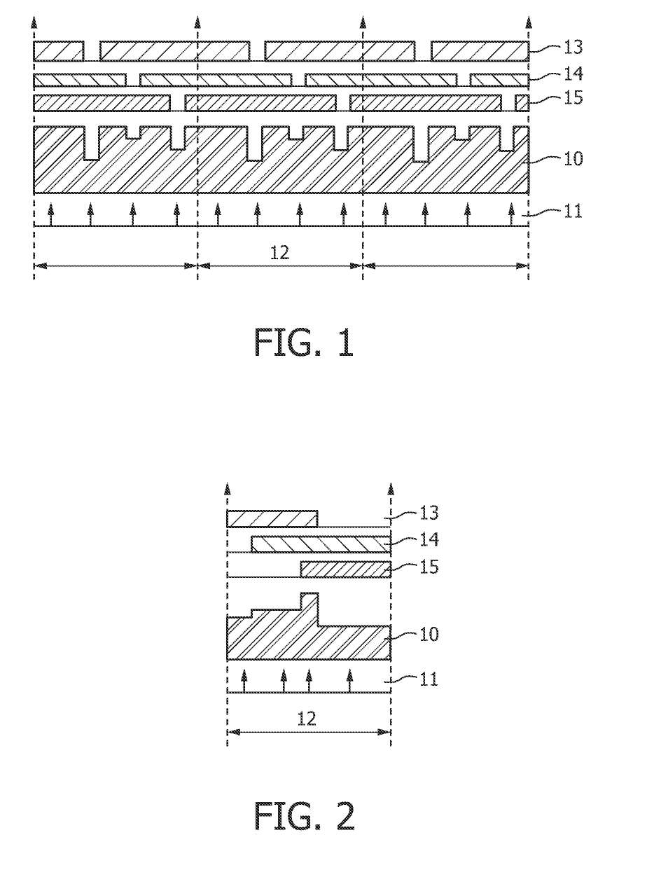

FIG. 1 shows a diagram illustrating flux measurement for amplitude modulated LEDs according to U.S. Pat. No. 6,127,783. Flux measurements 10 are triggered by sampling pulses 11. In each measure sequence 12 the flux 10 for each of the three colors red, green and blue is determined. The sampling pulses 11 triggering the flux measurements 10 must be synchronized with the LED current pulses 13, 14, 15. Equally spaced sampling pulses 11 are used frequently. The measured flux values 10 resulting from the measure sequences are incorporated into a cycle-by-cycle color control of the LED lamp.

FIG. 2 shows a diagram illustrating flux measurement for pulse width modulated LEDs according to U.S. Pat. No. 6,507,159. The time length of the measure sequence 12 can no longer be chosen freely but is equal to the PWM period. Furthermore, the current pulses 13, 14, 15 must be timed such that each color is switched on for the required duty cycle. This imposes severe limitations on the proper location of the sampling pulses 11 that need to be synchronized with and properly placed within the pattern of current pulses 13, 14, 15.

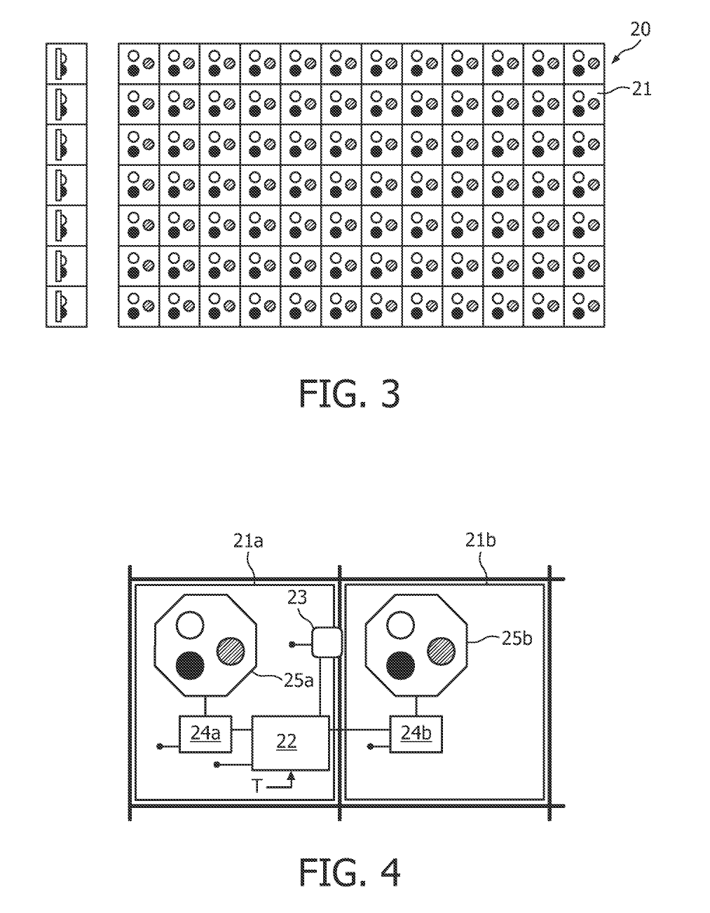

FIG. 3 shows a segmented LED-based LCD backlight 20. In the example shown in FIG. 3, the backlight 20 (also called LED lamp array or, more generally, LED lamp unit) consists of 7*12=72 LED lamps 21 (also called segments or LED lamp unit) arranged in a matrix. In such a LCD backlight 20, the above described problems (complicated timing of current pulses and sampling pulses, large computational efforts) exist.

Furthermore, for this kind of LED light units it is desirable that either all or at least some of the LED lamps share part of the hardware, e.g. sensors or controllers as shown for two LED lamps 21a, 21b (i.e. segments of the LED light unit 20) in FIG. 4. The two LED lamps (segments) 21a and 21b of the segmented LCD backlight 20 depicted in FIG. 3 share the controller 22 and the sensor 23. However, each segment has its own driver 24a, 24b and its own LED light source 25a and 25b. Then, the number of LED strings to be controlled by one sensor 23 and controller 22 would be considerably larger than for a lamp with three or more primary colors. Furthermore, it may be impractical to isolate the segments optically from each other, which would result in significant crosstalk between the segments, i.e. each LED string influencing virtually all optical sensors.

The setup of the general system and hardware as proposed by the present invention is the same as described above for the prior art, e.g. in the above mentioned U.S. Pat. No. 6,596,977. However, it is important to note that it can be applied also to other system/hardware configurations.

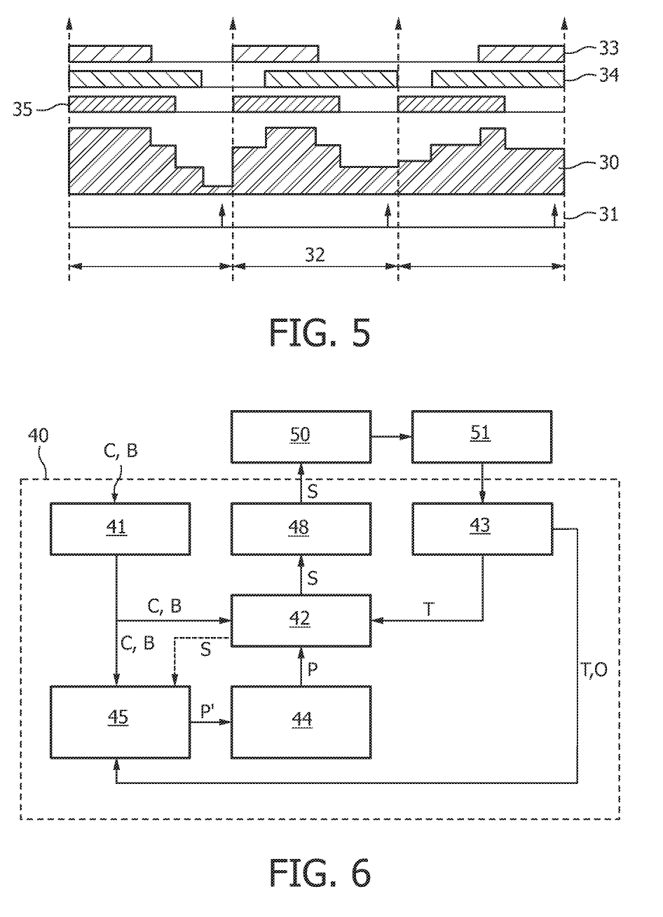

FIG. 5 shows an example of the timing of the sampling puls(es) 31 and current pulses 33, 34, 35 according to the present invention. There is one sampling pulse 31 located close to the end of the PWM period. This is done such that the measurement is finished before the next PWM period 32 begins. All current pulses 33, 34, 35 start normally at the beginning of the PWM period 32 and will therefore not reach into the sampling pulse 31. This can be guaranteed by limiting the maximum length of the current pulses to e.g. 95% of the PWM period. In each PWM period 32, some current pulses 33, 34, 35 are shifted towards the end of the PWM period 32 such that the desired combination of LED colors is switched on at the sampling pulse 31 when the flux measurement 30 is taken. The procedure that measures and updates the factors relating the duty cycles to the brightness values triggers these measurements and evaluates them. Whilst the measurements are synchronized with the PWM, the procedure itself can run considerably slower and updates the factors asynchronously, because as mentioned above influence factors also change slowly.

FIG. 6 shows a block diagram of a first embodiment of an LED lamp including a device 40 implementing the model-based color control according to the present invention. The device 40 is adapted for controlling the color point of an LED light source 50 and comprises a parameter input 41 for receiving color point information C and brightness information B indicating a desired color point and brightness of the LED light source 50. Further, a measurement input 43 is provided for receiving temperature information T and optical output information O indicating i) a temperature, ii) a color and/or iii) brightness (preferably indicating temperature, color and brightness) of said LED light source 50 and/or fluxes of the primary colors of said LED light source 50 from a respective sensor unit 51. A feed forward calculation unit 42 is provided for determining control parameters S for controlling the color point of said LED light source 50 by using a feed forward algorithm based on said color point information C, said brightness information B, said temperature information T and feed forward parameters P.

Preferably, the feed forward calculation unit 42 calculates the duty cycle of a PWM and/or the amplitude AM control signal S for each LED string of said LED light source 50 in an equal manner. Advantageously, the feed forward calculation unit 42 is implemented in programmable logic, e.g. as FPGA, but other implementations (pure (analog or digital) hardware, pure software or a mixture of both) are possible as well. Said control parameters S will be outputted by a parameter output 48 to said LED light source 50.

A feed forward parameter storage unit 44 is provided for storing said feed forward parameters P, and a feed forward parameter correction unit 45 is provided for determining actual feed forward parameters P′, based on the information received by said parameter input 41 and said measurement input 43, i.e. based on said color point information C, said brightness information B, said temperature information T and said optical output information O, and for updating the feed forward parameters P stored in said feed forward parameter storage unit 44 by said actual feed forward parameters P′.

In the feed forward parameter correction unit 45 different tasks are performed, for which logic decisions have to be taken: averaging over several measurements (e.g. by using a moving average filter); identifying and discarding erroneous measurements, which can appear if a separate lamp is switched on and off during the measurement; comparison with earlier measurements/feed forward parameters, which are stored in a non-volatile memory. The feed forward parameter correction unit 45 is best implemented by a micro-controller or DSP, while other implementations are possible as well in the same way as mentioned above for the feed forward calculation unit 42.

The control signals S can, in addition, also be provided to the feed forward parameter correction unit 45, as indicated by the dashed line in FIG. 6. Whether or not this is done, depends on the detailed implementation. In particular, if calculation time should be saved, the control signals S are preferably provided also to the feed forward parameter correction unit 45, but if there is shortage of storage, they are not forwarded.

Hence, according to the present invention the feed forward parameter correction unit 45 is continuously active and thus does not wait until a certain condition is fulfilled, e.g. until a certain temperature exceeds a predetermined temperature limit, before it becomes active. In this way, a better and more stable control of the color point of the LED light source 50 can be achieved.

The feed forward parameter storage unit 44 stores in a rewriteable non-volatile memory the parameters which are required by the feed forward algorithm in order to determine the control variables for the LED light source 50 from the received information (color point, brightness, measured temperature, and, if necessary, control signal). In a calibration process, feed forward parameters, which are influenced by manufacturing variations, are stored there. The parameter correction algorithm updates these data, if this has become required due to aging. In this way the LED light unit 50 does also work correctly if the parameter correction algorithm cannot work at all or not in a meaningful manner. The stored parameters are also read from the storage 44 by the feed forward calculation unit 42 when the LED light source 50 is switched on, which avoids the necessity of the feed forward calculation unit 42 accommodating a permanent storage of its own.

It is important to note here that this scheme may be modified considerably. It is not necessary to take a measurement in each PWM period 32. Furthermore, the location of the sampling pulse 31 in the PWM period 32 need not be fixed.

Quick changes in the LED flux model are not needed because the physical changes of the LED system are slow, so that cheaper micro-controllers can be used.

The model parameters can easily be stored, so the color is correct from power-up (compared to run-in time of loop implementation). A model of degradation and color-shift of LEDs can be created to reduce the impact of sensor degradation on the feed forward model.

In the following, a more detailed explanation will be provided. The light to be emitted by a LED lamp is specified by its chromaticity coordinates x and y (this is the color point) and its luminous flux Φₗᵤₘ (this is the brightness). From these the tristimulus values X, Y, and Z are calculated.

$$Y = \frac{{Φ}_{lum}}{683 \frac{lm}{W}}$$

$$X = x \frac{Y}{y}$$

$$Z = z \frac{Y}{y} = ( 1 - x - y ) \frac{Y}{y} .$$

The parameter input 41 provides x, y, and Φₗᵤₘ or X, Y, and Z to the feed forward parameter correction unit 45 and to the feed forward calculation unit 42.

The tristimulus values are grouped into a vector TV (Tristimulus Values).

$$\underline{TV} = ( \begin{matrix}X \\ Y \\ Z\end{matrix} ) .$$

The control signals for the drivers for the red, green, and blue LEDs are grouped into a vector CS (Control Signals)

$$\underline{CS} = ( \begin{matrix}r \\ g \\ b\end{matrix} ) .$$

These may be duty cycles for a pulse width modulation control or current amplitudes for an amplitude modulation control.

The tristimulus values depend on the control signals in a non-linear way. For practical purposes, this relation can be expressed as a second order polynomial.

$${CS}_{\underline{\_}} = ( \begin{matrix}r & 0 & 0 \\ 0 & g & 0 \\ 0 & 0 & b\end{matrix} )$$

$$\underline{TV} = {C 2 T 1}_{\underline{\_}} \cdot \underline{CS} + {C 2 T 2}_{\underline{\_}} \cdot {CS}_{\underline{\_}} \cdot \underline{CS}$$

$$\underline{TV} = ( {C 2 T 1}_{\underline{\_}} + {C 2 T 2}_{\underline{\_}} \cdot {CS}_{\underline{\_}} ) \cdot \underline{CS} .$$

The feed forward parameter storage unit 44 stores C2T1 and C2T2 as a function of the LED temperatures (distinguishing between red, green, and blue).

The feed forward calculation unit 42 extracts C2T1 and C2T2 for the measured LED temperatures. Then it determines CS from TV in an iterative way using the relation

CS=(C2T1+C2T2·CS)⁻¹·TV

(receive CS from the previous iteration step, update C2T1, C2T2, and TV, calculate CS, give CS to parameter output, update elements of CS by elements of CS, go to next iteration step).

LED light output characteristics vary with forward current amplitude, junction temperature, manufacturing spread, and aging. The feed forward control described above accounts for the dependence on current amplitude, junction temperature, and manufacturing spread.

The major effect of aging is a reduction of LED brightness for a given forward current amplitude and junction temperature. This is accounted for in the feed forward parameter correction unit. In a straightforward simplified model, factors describing quantitatively the reduction of LED brightness are stored in a matrix AR.

$${AR}_{\underline{\_}} = ( \begin{matrix}AR r & 0 & 0 \\ 0 & AR g & 0 \\ 0 & 0 & AR b\end{matrix} ) .$$

Actual light output is then given as

TV=(C2T1·AR+C2T2·AR·CS)·CS.

Control signals are then determined using the relation

CS=(C2T1·AR+C2T2·AR·CS)⁻¹TV.

Aging of light output affects both tristimulus values and optical sensor readings. As to the sensor readings, a color sensor is discussed in the following.

The values R, G, and B sensed by the color sensor are grouped into a vector SR (Sensor Readings)

$$\underline{SR} = ( \begin{matrix}R \\ G \\ B\end{matrix} ) .$$

Sensor readings depend on control signals similar to tristimulus values

SR=(C2S1+C2S2·CS)·AR·CS

These are predicted sensor readings. The elements of AR can be determined from comparing measured and predicted readings. AR will not be updated cycle by cycle but instead by using e.g. a moving average filter.

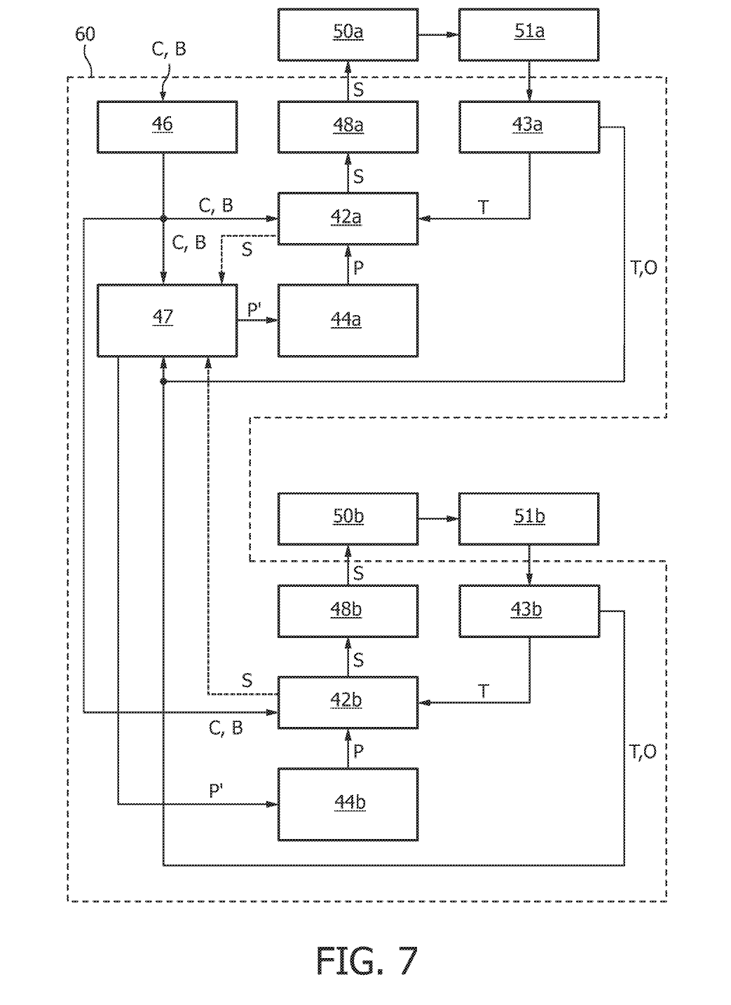

The complex part of the calculation (determining the parameters) can be done slowly, or even on a separate controller as illustrated in the block diagram of a further embodiment of an LED light unit (in particular an LED lamp array) including a further embodiment 60 of the device according to the present invention as shown in FIG. 7.

In the light unit shown in FIG. 7, two LED light sources 50a, 50b and two corresponding sensor units 51a, 51b will be controlled by the device 60. For each LED light source 50a, 50b a separate feed forward calculation unit 42a, 42b and a separate feed forward parameter storage unit 44a, 44b are provided. However, instead of separate feed forward parameter correction units, a centralized parameter input 46 and a centralized feed forward parameter correction unit 47 are provided, which receive control point information C and brightness information B (N-times), corresponding to the number of LED light sources at the parameter input 46. In other words, it is possible that several LED light sources share a common parameter input and/or a common feed forward parameter correction unit.

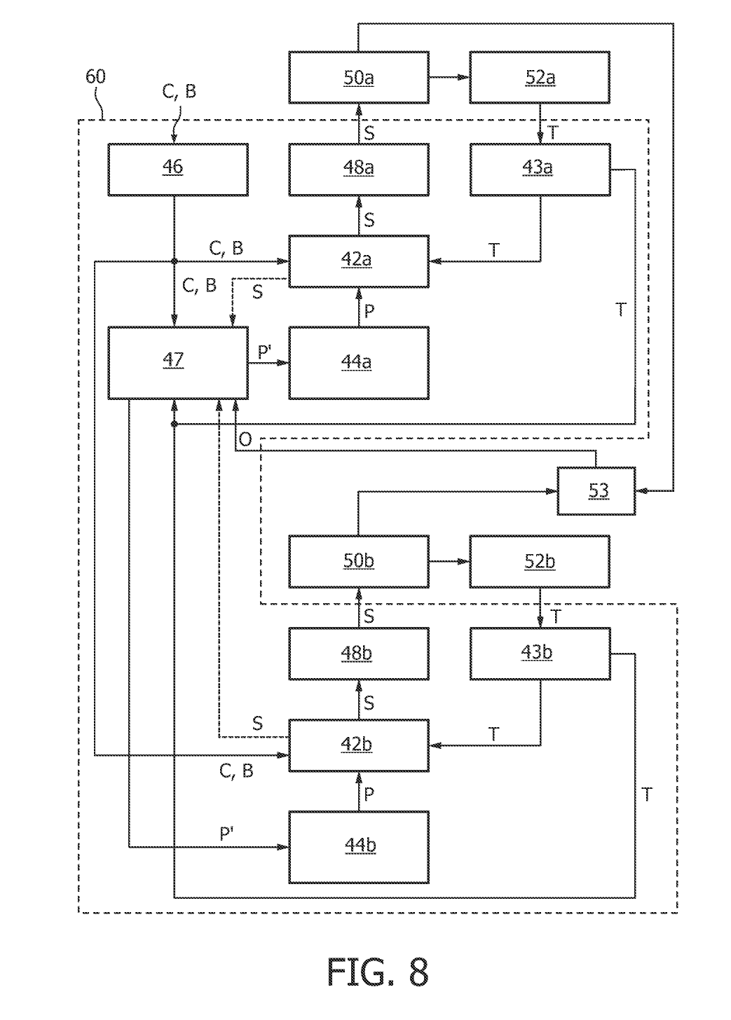

It is further possible that the LED light sources 50a, 50b share a common sensor unit, which further reduces the hardware required in such a system comprising more than one LED light source. This is particularly useful for an optical sensor, more so than for a temperature (thermal) sensor. Such an embodiment of an LED light unit is shown in FIG. 8, in which each LED light source 50a, 50b is provided with its own thermal sensor 52a, 52b, but they share a common optical sensor 53. The common optical sensor 53 could then directly forward the measured optical data O to the common feed forward parameter correction unit 47.

The present invention for controlling the color of RGB LED lamps can be applied in numerous solid-state light sources.

In summary, color point control is a most interesting product feature, both for white and colored LED light sources. Known methods for color control of RGB LED lamps comprise using flux and color sensors. However, there are difficulties with respect to sensing quickly changing ambient light, deeply dimmed colors, coordinating the measurements with the switching of the LEDs, and controlling the color in LED light sources comprising a number of independent LED lamps, e.g. segmented wall washers and LCD backlights. It is proposed according to the present invention to control the color of the LED light source by using a model-based feed forward approach. Factors relating the parameters controlling the LED currents to the brightness for the different colors (and segments) are stored and used for open loop control. A slowly running procedure continuously measures and updates these factors. Whilst the measurements are e.g. synchronized with the PWM, the procedure itself can run considerably slower and updates the factors asynchronously.

While the invention has been illustrated and described in detail in the drawings and the foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measures cannot be used to advantage.

A computer program may be stored/distributed on a suitable medium, such as an optical storage medium or a solid-state medium supplied together with or as part of other hardware, but may also be distributed in other forms, such as via the Internet or other wired or wireless telecommunication systems.

Any reference signs in the claims should not be construed as limiting the scope.

1. Device for controlling the color point of an LED light source (50), comprising:
a parameter input (41) for receiving color point information (C) and brightness information (B), indicating a desired color point and brightness of said LED light source (50),
a measurement input (43) for receiving temperature information (T) and optical output information (0) indicating) a temperature, ii) a color and/or iii) brightness of said LED light source (50) and/or fluxes of the primary colors of said LED light source (50),
a feed forward calculation unit (42) for determining control parameters (S) for controlling the color point of said LED light source (50) by using a feed forward algorithm based on said color point information (C), said brightness information (B), said temperature information (T) and feed forward parameters (P),
a parameter output (48) for outputting said control parameters (S) to said LED light source (50),
a feed forward parameter storage unit (44) for storing said feed forward parameters (P), and
a feed forward parameter correction unit (45) for determining actual feed forward parameters (P′) based on the information received by said parameter input (41) and said measurement input (43) and for updating the feed forward parameters (P) stored in said feed forward parameter storage unit (44) by said actual feed forward parameters (P′).

2. Device as claimed in claim 1,
wherein said forward parameter correction unit (45) is adapted to update the feed forward parameters (P) stored in said feed forward parameter storage unit (44) by said actual feed forward parameters (P′), if the deviation between said actual feed forward parameters (P′) and said feed forward parameters (P) stored in said feed forward parameter storage unit (45) exceeds a predetermined limit.

3. Device as claimed in claim 1,
wherein said forward parameter correction unit (45) is continuously active to continuously update the feed forward parameters (P) stored in said feed forward parameter storage unit (44).

4. Device as claimed in claim 1,
wherein said forward parameter correction unit (45) is adapted for asynchronously updating the feed forward parameters (P) stored in said feed forward parameter storage unit (44).

5. Device as claimed in claim 1,
wherein said feed forward calculation unit (42) is adapted for determining pulse width modulation parameters or amplitude modulation parameters as said control parameters (S).

6. LED light unit comprising:
a LED light source (50),
a sensor unit (51) for sensing i) temperature and ii) color and/or flux and for generating temperature information (T) and optical output information (0) indicating i) a temperature, ii) a color and/or iii) brightness of said LED light source (50) and/or fluxes of the primary colors of said LED light source (50),
a device (40, 60) as claimed in claim 1 for controlling the color point of said LED light source (50).

7. LED light unit as claimed in claim 6,
wherein said sensor unit (51) comprises a color sensor for measuring the color of said LED light source (50).

8. LED light unit as claimed in claim 6,
wherein said sensor unit (51) comprises a photodiode for measuring the brightness of said LED light source (50).

9. LED light unit as claimed in claim 6,
wherein said sensor unit (51) is adapted for asynchronously measuring i) the temperature and ii) the color of said LED light source and/or fluxes of the primary colors of said LED light source (50).

10. LED light unit as claimed in claim 6,
wherein said LED light source (50) comprises two LED strings.

11. LED light unit as claimed in claim 6,
wherein said LED light source (50) comprises four or more LED strings.

12. LED light unit as claimed in claim 6,
comprising two or more LED light sources (50a, 50b), wherein said two or more LED light sources (50a, 50b) share a common parameter input (46), feed forward parameter correction unit (47) and/or optical sensor unit (53) for sensing color and/or flux of said LED light sources (50a, 50b).

13. Method for controlling the color point of an LED light source (50), comprising the steps of:
receiving color point information (C) and brightness information (B), indicating a desired color point and brightness of said LED light source (50),
receiving temperature information (T) and optical output information (0) indicating i) a temperature, ii) a color and/or iii) brightness of said LED light source (50) and/or fluxes of the primary colors of said LED light source (50),
determining control parameters (S) for controlling the color point of said LED light source (50) by using a feed forward algorithm based on said color point information (C), said brightness information (B), said temperature information (T) and feed forward parameters (P),
outputting said control parameters (S) to said LED light source (50),
storing said feed forward parameters (P),
determining actual feed forward parameters (P′) based on the information received by said parameter input (41) and said measurement input (43), and
updating the feed forward parameters (P) by said actual feed forward parameters (P′).

14. Computer program comprising program code means for causing a computer to carry out the steps of the method as claimed in claim 13 when said computer program is carried out on a computer.
